(19) United States
(12) Patent Application Publication
(10) Pub. No.: US 2009/0248314 A1
(43) Pub. Date: Oct. 1, 2009

(54) Network-based system and method for diagnostic pathology

(76) Inventors: Dennis M. Frisman, San Diego, CA (US); L. Charles Clark, Salt Lake City, UT (US); Elizabeth Hammond, Salt Lake City, UT (US); H. Ric Harnsberger, Salt Lake City, UT (US); Kent Dixon Haynes, Sandy, UT (US); Jonathan T. House, Sandy, UT (US); Nathaniel M. Jones, West Jordan, UT (US); Daniel Z. Phillips, Salt Lake City, UT (US); Paul F. Scholtes, Laguna Hills, CA (US)

Correspondence Address: Workman Nydegger;1000 Eagle Gate Tower, 60 East South Temple, Salt Lake City, UT, 84111, US

(21) Appl. No.: 12/079,252

(22) Filed: Mar. 25, 2008

(51) Int. Cl. G06F 19/00; H04L 9/32; G06N 5/02; G06F 7/06; G06F 17/30

(52) U.S. Cl. 702/19; 726/5; 706/52; 707/4; 707/E17.014; 707/E17.044

(57) ABSTRACT

An optimized network-based system and method for providing reagents or reagent-like matter for the differential diagnosis of medical conditions using a hosted software program coupled with a comprehensive medical reference database. Suspected diagnoses of medical conditions are entered into the system by a user. Using meta-analysis, the system generates a list of potential reagents and numerical measures of each reagent's behavior for each differential for use in further testing. The results of the testing are compared by the user against numerical measures of each reagent's behavior and corresponding stored digital images in the network-based system. The user then selects among those diagnoses in the system whose images and corresponding numerical measures of each reagent's behavior are most comparable with the results of the testing. The system then generates a diagnosis, diagnoses, or inconclusive results in order to reach an ultimate diagnosis.

### BACKGROUND OF THE INVENTION

1. Field of the Invention

The field of the invention is network- and software-based diagnostic pathology.

2. Description of the Background

Methods for the diagnosis and treatment of serious medical conditions are increasingly important. By way of example, cancer is currently a major cause of death in the world, and is overtaking cardiovascular disease as the leading cause of death in Western countries. The optimization of tools for the diagnosis and treatment of cancer is paramount. One important tool in the diagnosis of cancer is immunohistochemistry. Immunohistochemistry is the process of localizing proteins in cells or a tissue section by exploiting the principle of antibodies—acting as reagents—binding specifically to antigens in biological tissues and is frequently used in the diagnosis and treatment of cancer. More particularly, immunohistochemical staining (“immunostaining”) is a form of testing that allows pathologists to conduct immunohistochemistry for diagnostic purposes. Through immunostaining, specific molecular markers detected by antibodies indicate to pathologists the presence of particular cancer types. Accordingly, pathologists dealing with potentially cancerous tumors are required to have a broad understanding of antibodies and immunohistochemistry to select groups of antibodies for use in immunostaining in order to make differential diagnoses of similarly appearing tumors.

In addition to immunohistochemistry for the diagnosis of cancer, many other types of reagents or reagent-like substances or representations are used for the purpose of differential diagnosis or prediction of medical conditions. These include but are not limited to immunofluorescense, histochemistry, and molecular pathology, to name a few. Pathologists diagnosing and treating these conditions are equally tasked with having a broad understanding of the various reagents used in the differential diagnosis of these conditions.

Significantly, in recent years there has been a commercial explosion of available antibody reagents for the purposes of diagnosing cancer, and this trend may be presumed to extend to the reagents available for diagnosis of other medical conditions. Concurrent with this trend, determining the best panels of antibodies for immunostaining has become increasingly challenging and time consuming for physicians. Despite the trend, and the problems associated with it, there have been very few efforts to provide an easy way to determine the best groups of antibodies for immunostaining that will aid in the differential diagnosis of tumors. One internet-based system which has been developed in the recent past was ImmunoQuery®. ImmunoQuery® was a successful immunochemistry database query system that would list antibodies for differentiation purposes, rank the antibodies in terms of their ability to differentiate between cancerous conditions, and provide instant references to medical references relating to the antibodies. However, ImmunoQuery® was generally a diagnostic toolbox, and did not utilize a step-by-step or workflow optimized diagnostic system. Moreover, ImmunoQuery® did not use digital images for diagnostic purposes.

Therefore, there is a significant and ongoing need in the diagnosing and treating medical community for a universal step-by-step tool which incorporates a comprehensive database of reagents, optimizes the process of selecting proper groups of reagents for further testing in connection with differential diagnosis, and which allows pathologists to correctly and easily interpret the results of the testing using these reagents by providing a reference to digital images in addition to important numerical measures which correspond to the testing results.

### SUMMARY OF THE INVENTION

In accordance with the above, an innovative diagnostic system and method is provided. A network-based system is used to collect preliminary diagnosis hypotheses from treating physicians and staff, to recommend customized groups of reagents for further testing based on pathologist input and a wide range of medical reference data, and to provide digital images of positive and negative testing results in addition to numerical measures of reagent behavior to assist pathologists in interpreting the results of laboratory testing based on the recommended reagents. The invention results in an accurate, step-by-step, work flow optimized system and method for making differential diagnoses of medical conditions through the use of reagents or reagent-like materials or representations.

### BRIEF DESCRIPTION OF THE FIGURES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

FIG. 1 is a block diagram generally illustrating the steps of the diagnostic system and method claimed according to one embodiment of the present invention.

FIG. 2 is a screen print of a home page of a network-based system which provides a login for access, as well as other tools and features according to one embodiment of the present invention.

FIG. 3 is a screen print of a page in a network-based system for entering suspected diagnoses according to one embodiment of the present invention.

FIG. 4 is a screen print of a page in a network-based system which represents a list of potential reagents for testing, along with their properties, as indicated by various numerical measures, generated by entering the suspected diagnoses according to one embodiment of the present invention.

FIG. 5 is a screen print of a page in an internet-based system which represents a list of recommended reagents for testing, along with their properties, as indicated by various numerical measures, generated by entering the suspected diagnoses according to one embodiment of the present invention.

FIG. 6 is a screen print of a page from a network-based system that shows a large digital image view of a reference testing result according to one embodiment of the present invention.

FIG. 7 is a screen print of a page from a network-based system that shows saved cases according to one embodiment of the present invention.

FIG. 8 is a screen print of a page from a network-based system that shows the system's prompt for entry of the user's assessment of test results according to one embodiment of the present invention.

FIG. 9 is a screen print of a page from a network-based system that shows the results of input of test results and the system's indication of a conclusive diagnosis according to one embodiment of the present invention.

FIG. 10 is a screen print of a page from a network-based system that shows a feature which allows the user to obtain a diagnosis or to narrow possible diagnoses based upon the entry of a reagent or group of reagents according to one embodiment of the present invention.

FIG. 11 is a screen print of a page from a network-based system that shows the results of input of a reagent or group of reagents by using the feature described in FIG. 10 according to one embodiment of the present invention.

FIG. 12 is a screen print of a page from an internet-based system that shows a feature which allows a user to compare up to five reagents with a suspected diagnosis group according to one embodiment of the present invention.

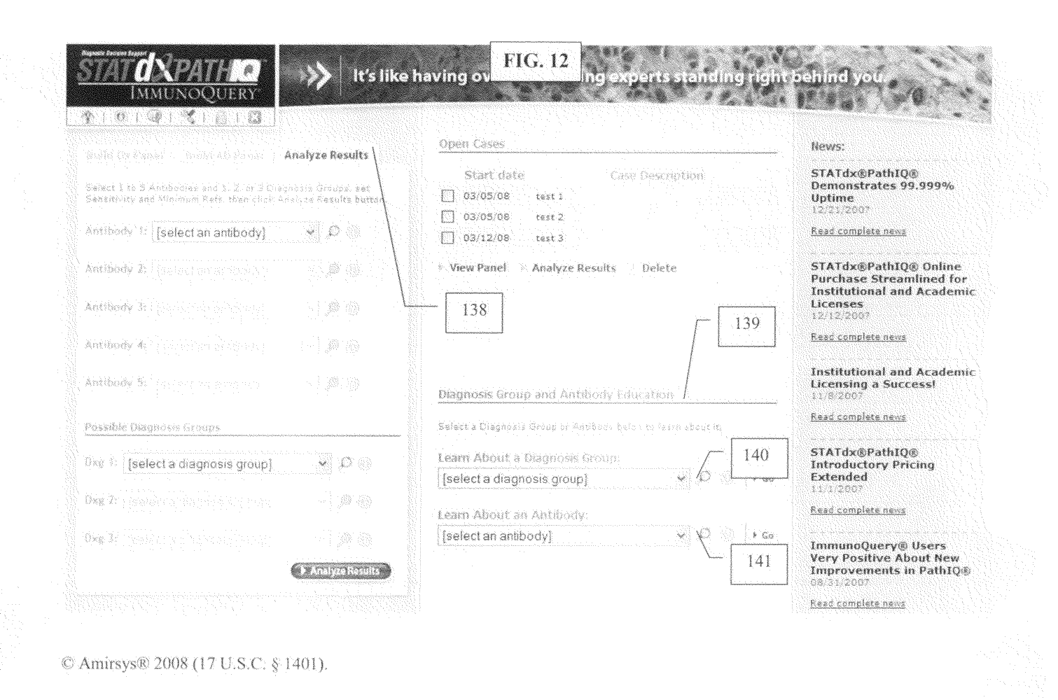

### DETAILED DESCRIPTION OF THE ILLUSTRATED EMBODIMENT

The present invention in its various embodiments is a network-based system and method for recommending reagents or reagent-like materials or representations to a pathologist or other individual (hereinafter referred to as “user”) for the differential diagnosis of, among other diagnoses, medical conditions. More specifically, as defined herein and as used for the purposes of the present invention, the term “reagent” may encompass any substance, material, or representation which is used to indicate the presence or possible presence of another substance, material, or representation.

Once a user suspects potential diagnoses, these diagnoses are entered into the network-based system. Based on this data, the system generates a list of potential reagents for use in further testing required for conclusive differential diagnosis. The recommended reagents, or a subset thereof, are made subject to reaction or further testing and the results of the testing are compared with stored digital images and corresponding numerical measures of reagent behavior in the network-based system. The user then makes a selection from among those diagnoses in the system whose images and corresponding numerical measures of each reagent's behavior are most comparable with the results of the testing. Using this selection, the system then generates a diagnosis, diagnoses, or inconclusive results, the latter of which requires additional meta-analysis in the system or the repetition of certain steps in the method to obtain a conclusive diagnosis.

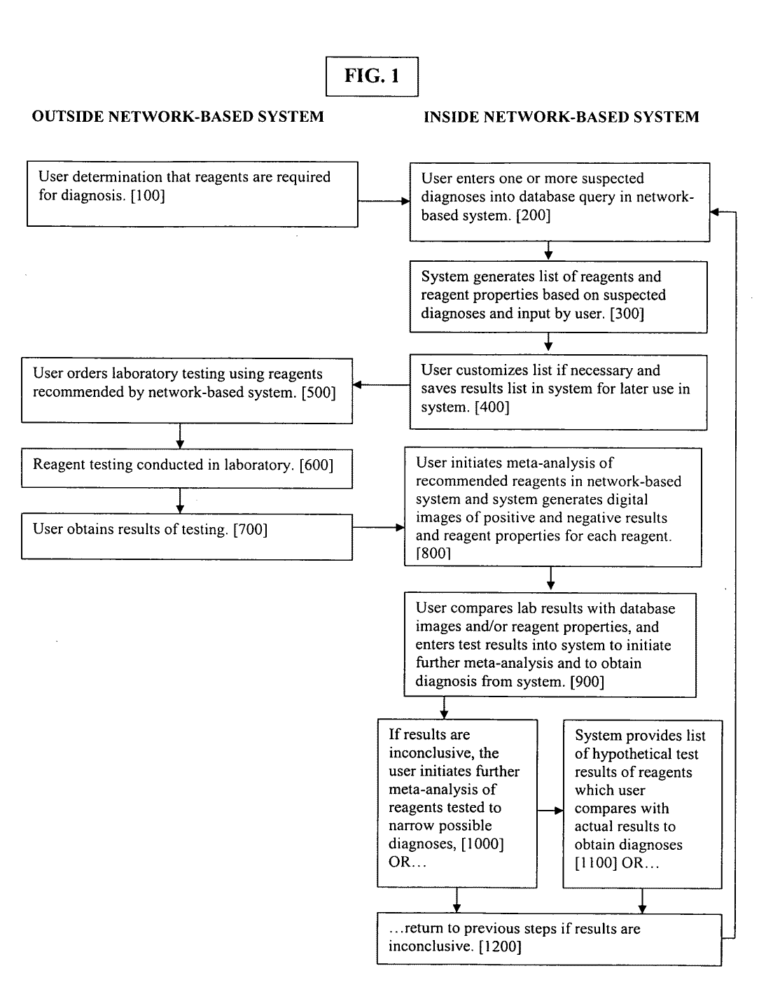

FIG. 1 is a flow chart that generally illustrates the system and method claimed by delineating the steps involved by reference to whether they occur outside or inside the internet-based system. Steps which mainly occur outside of the network-based system of the overall method are illustrated in the left column, while the steps of the method which mainly occur through the use of the network-based system are illustrated in the right column.

The method begins once a user determines that reagents will be required for diagnosis of a medical condition [100]. At this point, the user will likely have some idea as to potential diagnoses. Using this preliminary information, the user will access the network-based system. Generally, and according to one embodiment of the invention, the network-based system utilizes a software program maintained or hosted on a central server or servers which are remotely accessible by a user over the internet. However, the system could also consist of a smaller and more localized network, or even the use of software installed on a single computer terminal.

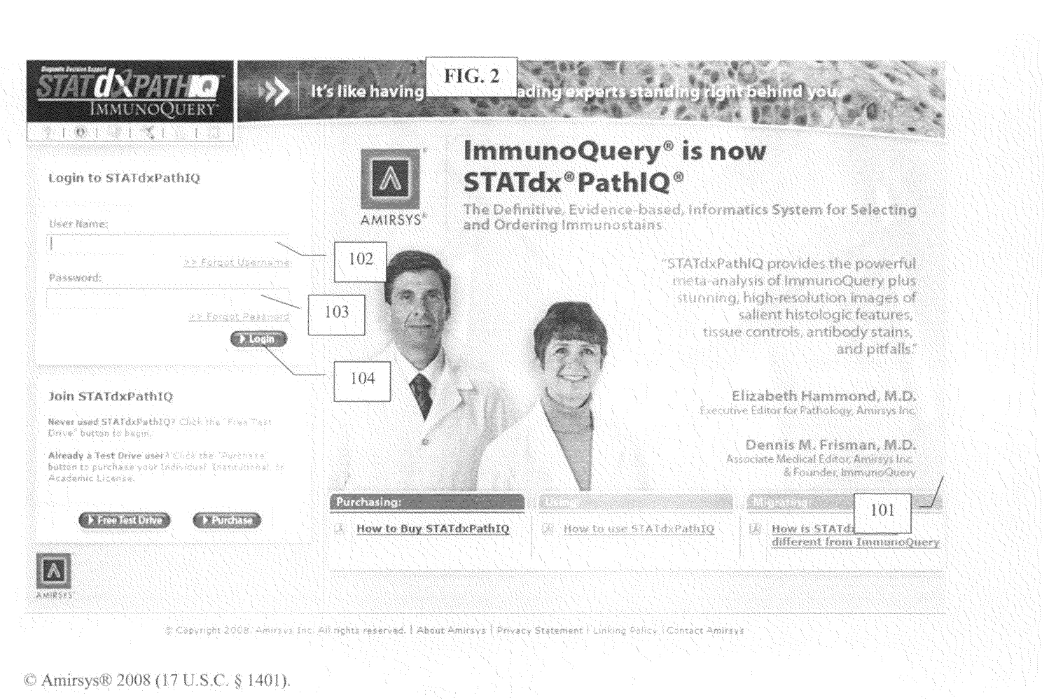

The preferred embodiment is a web-based product named STATdx™PathIQ™, and consists of subscription-based software accessible via login at the STATdx™PathIQ™ internet webpage [101], as shown in FIG. 2, by using a previously assigned username and password which is unique to each subscriber or user. The user enters the username and password into windows [101] and [102], respectively, and activates the login button [104].

STATdx™PathIQ™ utilizes a Java servlet-based back end with an HTML and CSS front end running on Resin's professional web server. STATdx™PathIQ™ further utilizes a Postgres database to store reference data and a Windows file system for storing images. The Resin server runs on Microsoft Windows 2003. Content is assembled in STATdx™PathIQ™ by using an XML-based authoring system which creates links between images, antibodies, diagnoses, and cases. An example of a suitable XML-based authoring system is that disclosed in patent application Ser. No. 10/723,018, which is hereby incorporated by reference. After content is assembled in an XML database, it is exported into a form which is compatible with the STATdx™PathIQ™ system. Content is also assembled in STATdx™PathIQ™ by use of a relational or table-based authoring system for entering diagnosis and reagent relations which have been manually parsed from peer reviewed medical references. This table is stored in a Postgres database that is compatible with STATdx™PathIQ™. Images and other content in STATdx™PathIQ™, which are discussed in more detail below, are served up from a web server and accessed from a web browser.

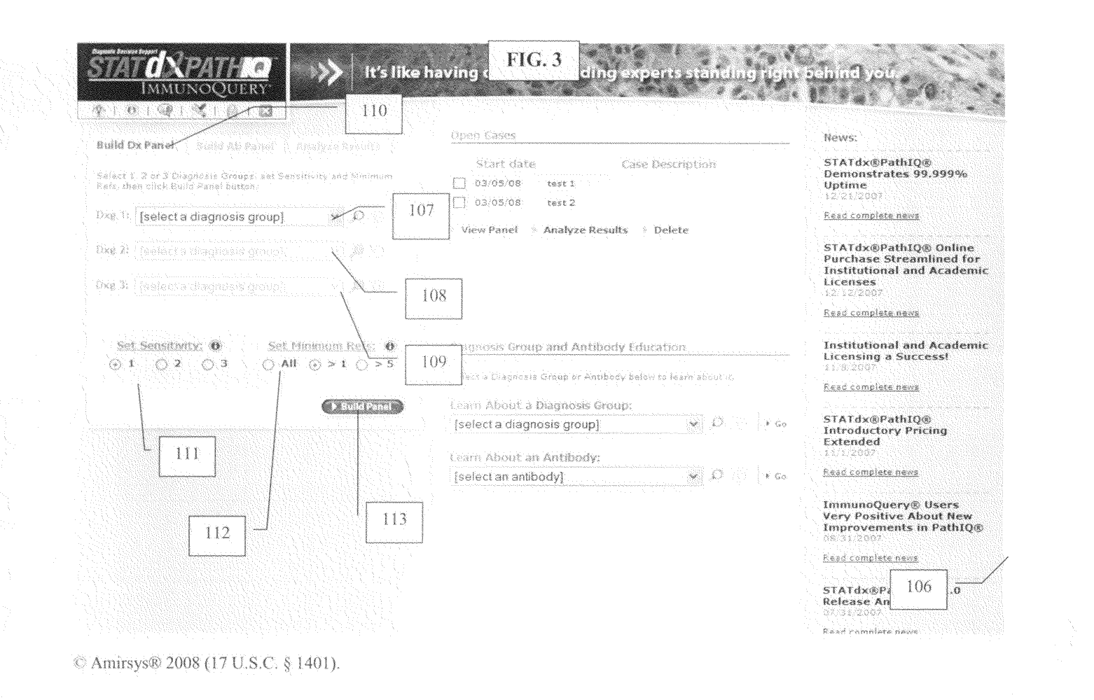

Upon accessing the network-based component, a user is presented with a query page or module [106] which allows the user to enter the suspected diagnosis or diagnoses [200]. In the preferred embodiment, this page is shown as FIG. 3 wherein the user may select up to three diagnoses from a listing of cancer types in the drop-down windows designated [107], [108], and [109]. The preferred embodiment facilitates this selection using a tab called “Build Dx Panel” [110]. This tab also contains a “Set Sensitivity” function [111], which allows a user to define the parameters for search sensitivity. The preferred embodiment allows a user to select a confidence level though a “Set Minimum Refs” function [112] to govern the meta-analysis. More specifically, the feature adjusts the confidence level corresponding to a search for appropriate antibody reagents by delineating the number of required medical references showing a correlation between a particular diagnosis or medical condition and an antibody for the search parameters. In the preferred embodiment, once the suspected diagnoses are selected, the user clicks the “Build Panel” button [113], as shown in FIG. 3. Regardless of the specific features of the preferred embodiment, any number of ways or features can be used to facilitate the entry of the suspected diagnoses into the network-based component for further meta-analysis.

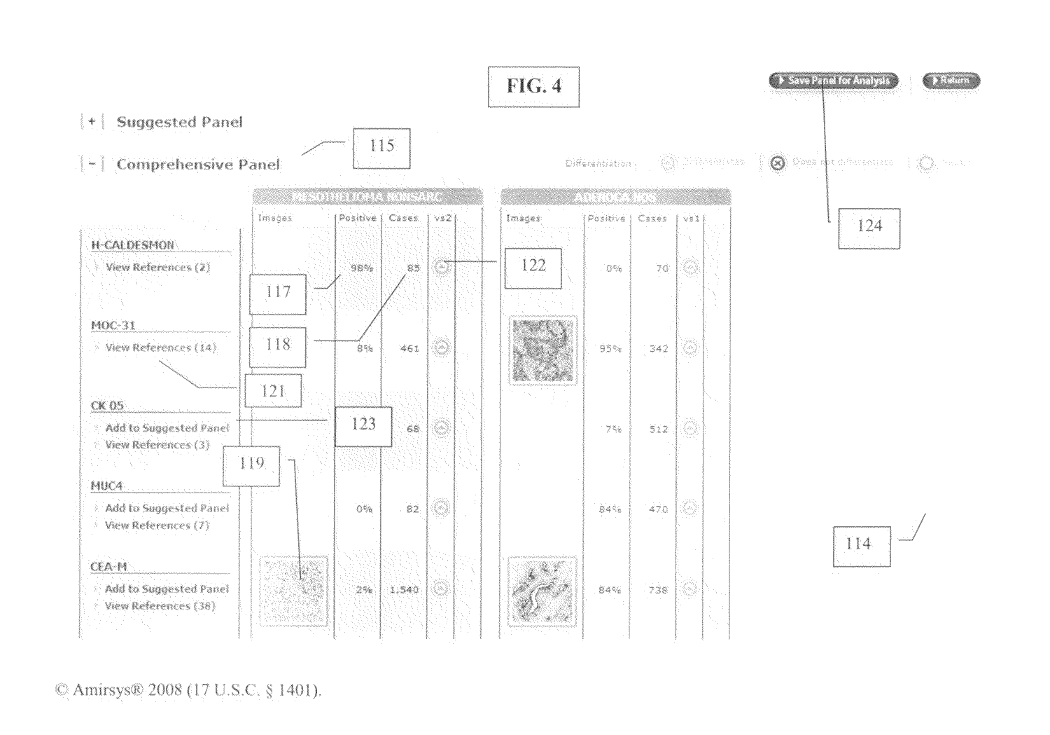

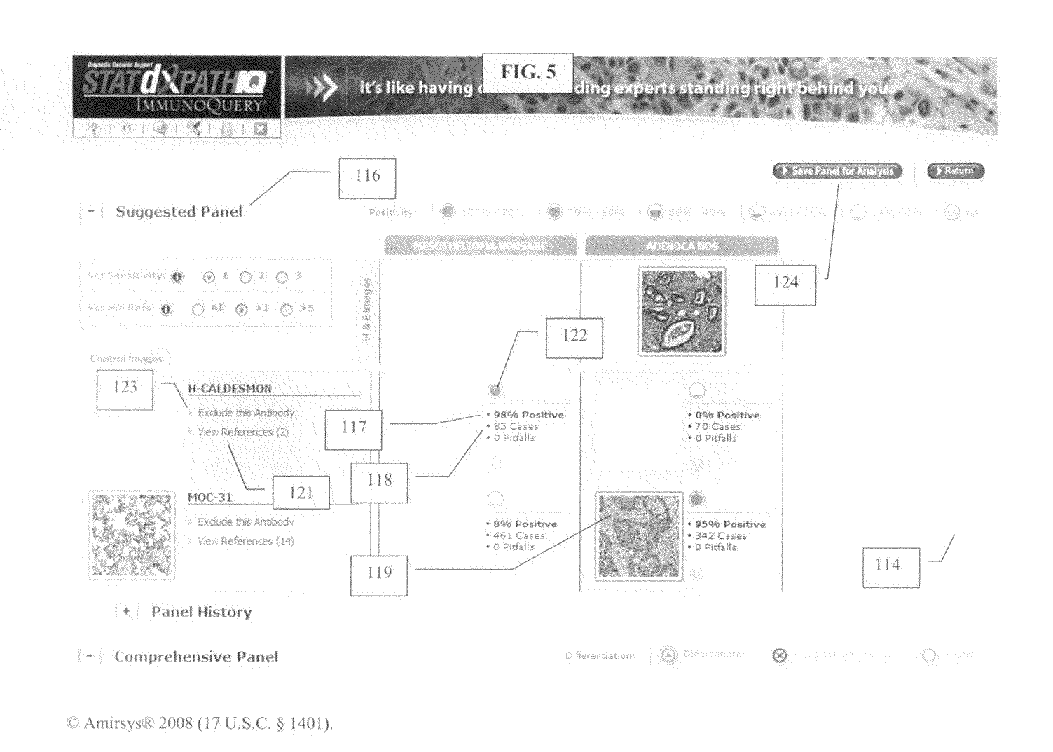

Once the suspected diagnoses are entered into the network-based system, the meta-analysis is initiated by the user, and the system, in response, generates a list of potential reagents and their properties, as reflected by various numerical measures, which would, through further testing or reaction, potentially differentiate among the diagnoses previously entered [300]. In the preferred embodiment, the results of this meta-analysis are displayed on a new page in the sequence [114], which is shown in FIG. 4 as a “Comprehensive Panel” or, if selected by a user, in FIG. 5 as a “Suggested Panel.” In the preferred embodiment, the “Comprehensive Panel” [115] is a comprehensive list of antibodies that may be useful in the differentiation of the entered diagnoses, whereas the “Suggested Panel” [116] is a narrower list of antibodies which are most likely to result in the greatest differentiation between the entered or suspected potential diagnoses.

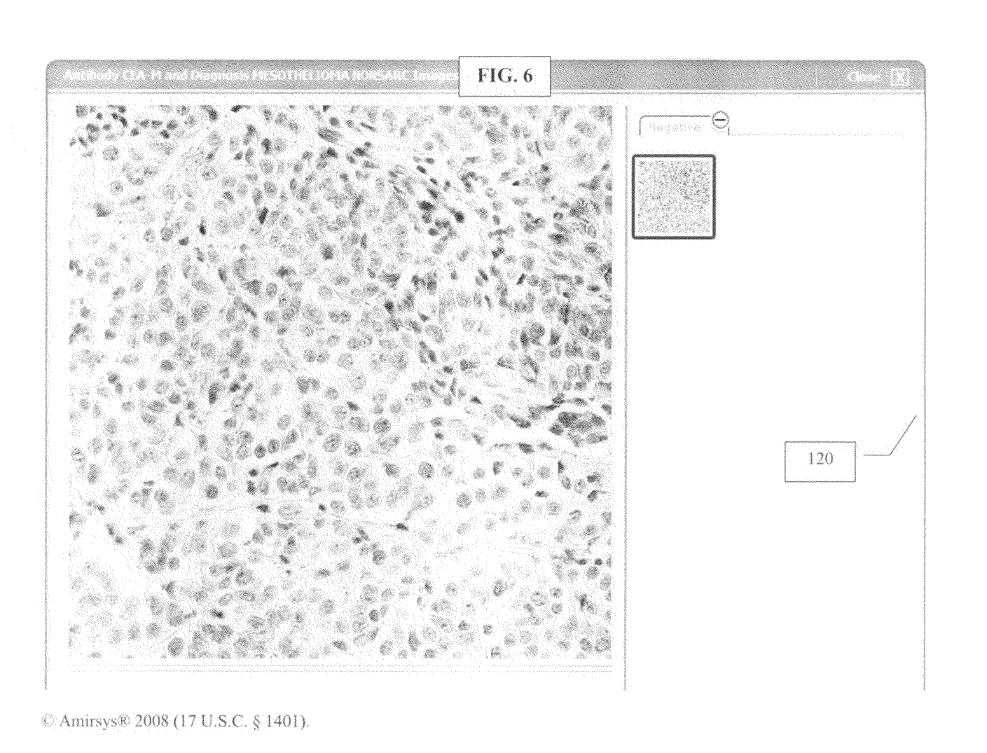

In the preferred embodiment, each of the Panels displays, for each antibody listed, various numerical measures of antibody behavior including a percentage [117] representing the correlation between an entered diagnosis and a positive immunostaining result, the total number of reported cases [118] from which the percentage is derived, as well as images [119] of positive and/or negative immunostain results. The images may be enhanced by the selection thereof initiated by a user, resulting in a pop-up window including an enlargement of the image along with its thumbnail image [120], as shown in FIG. 6. The pop-up window may include other related thumbnail images, if available, that may be selected for enlargement. Moreover, the preferred embodiment contains a feature which allows a user to view and review various medical references for each antibody [121]. The preferred embodiment also provides other features which rank and display the rank of the various antibodies based on their ability to differentiate from among the selected diagnoses through immunostaining and antibody reactivity, or characterize antibody reactivity [122], and which otherwise allow a user to customize Panels [123]. The customization of Panels may be made by a user by adding or deleting antibodies from the “Suggested Panel” for any number of reasons, including through the user's interpretation of the various numerical measures demonstrating the properties of the various antibodies or the user's review of medical reference information obtained through the system. Regardless of the specific features of the preferred embodiment, any number of ways or features can be used to display the reagents which the system has determined relevant to the suspected diagnoses.

In the preferred embodiment, once the network-based system has generated a list of possible and/or recommended antibodies for immunostaining, and any adjustments to the list have been made by the user, the user may click “Save Panel for Analysis” [124] as shown in FIGS. 4 and 5 This allows the user to save each Panel or antibody list for each particular query or patient case for later use by a user in the system [400].

Once a user has obtained a list of reagents from the network-based system, the user then orders testing or reaction of the reagents using some or all of the recommended reagents [500]. The testing may be conducted by any number of means, although, in the preferred embodiment, immunostaining using antibodies is conducted in the traditional laboratory environment [600]. After testing is completed, the user then obtains the results from the testing for each of the reagents [700], and visually examines them, which ordinarily, but not necessarily, entails microscopy examination of slides of tissue samples.

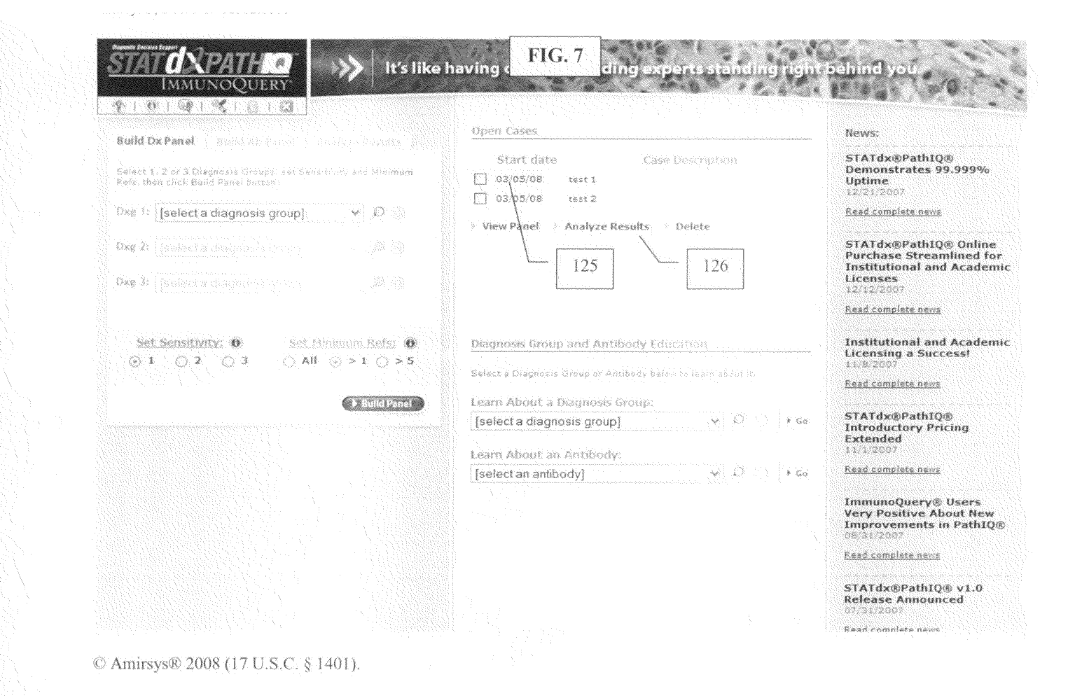

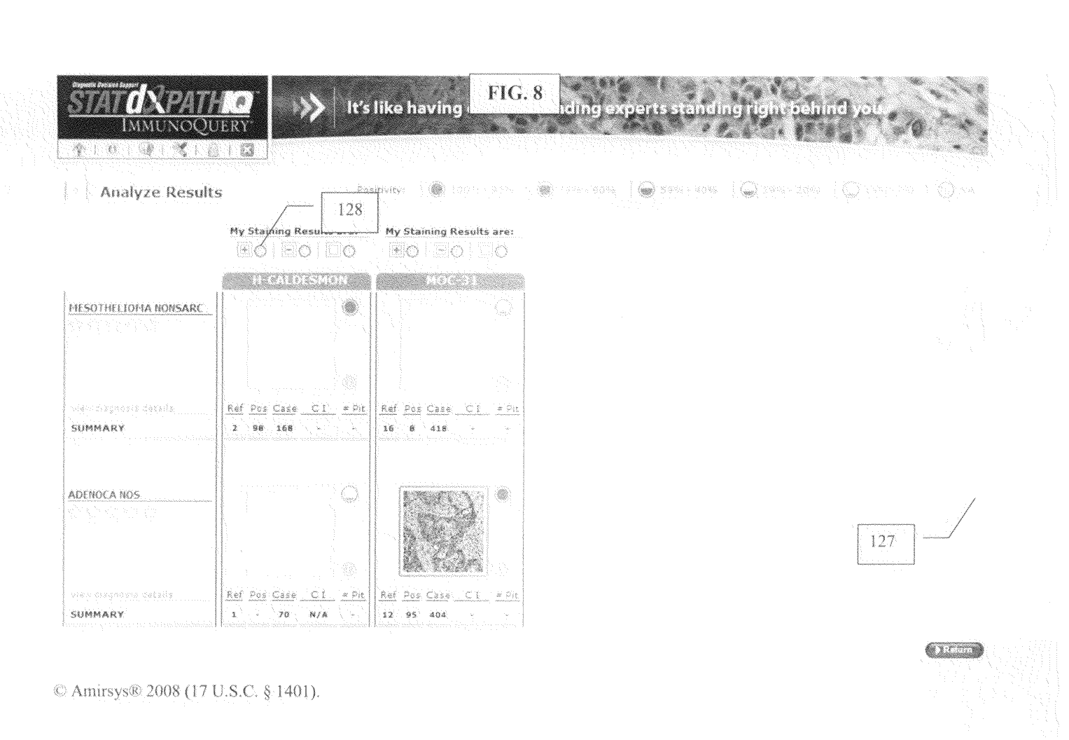

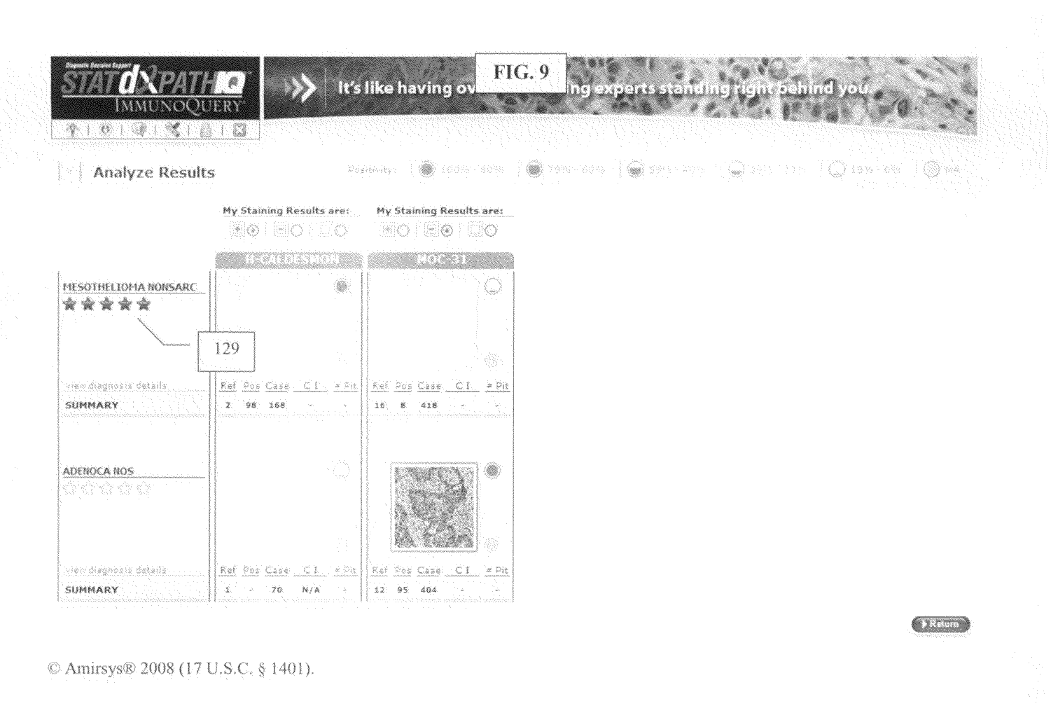

After the user has examined the results of the testing, the user again accesses the network-based system. In the preferred embodiment, the user, as discussed above, logs into the system, and selects the relevant saved list or Panel under “Open Cases” [125] as shown in FIG. 7. At this point, the user initiates a meta-analysis in the network-based system [800], which triggers the display in the system of digital images of positive or negative testing results and numerical measures of reagent behavior of the various reagents previously listed or selected by the user. The user then may visually compare the results of the testing with the digital images or compare test results with numerical measures of antibody behavior displayed in the network-based system, or compare test results with both digital images and numerical measures [900]. In the preferred embodiment, the user accomplishes this by clicking on an “Analyze Results” feature [126] as shown in FIG. 7. Initiating the “Analyze Results” feature presents the user with a new page [127] as shown in FIG. 8. On this page, the user may enter the results of the reagent testing [128], based on reference to comparable digital image immunostain results and/or numerical measures for each reagent. This action initiates further meta-analysis by the network-based system which, based on the input by the user, returns a probable diagnosis or diagnoses. The preferred embodiment displays this diagnosis by utilizing a star rating display [129] as shown on the left of FIG. 9.

It is also possible that the input by the user into the system initially fails to result in a diagnosis. At this stage, the user has two basic options. First, the user may initiate further meta-analysis in the system without regard to the initial diagnoses hypothesis [200], but rather, with respect to the reagents previously obtained from the system and tested [1000]. In other words, the user may enter the reagents previously tested into the system, whereby the system, using meta-analysis, generates a list of possible discrete diagnoses from which a user may select for differential diagnosis purposes. The user accomplishes this by comparing the actual testing results of the reagents previously selected and tested with the various permutations of hypothetical test results and their corresponding diagnoses in the generated list [1100]. This allows a user to significantly narrow possible diagnoses, and possibly attain a definitive diagnosis, without having to repeat steps [200]-[1000]. However, because of the possibility that the tested reagents are not sufficient to conclusively differentiate between diagnoses, it may result that a user only narrows possible diagnoses through this step and must obtain a conclusive diagnosis by repeating steps [200]-[1000] using the newly generated list of diagnoses [1200].

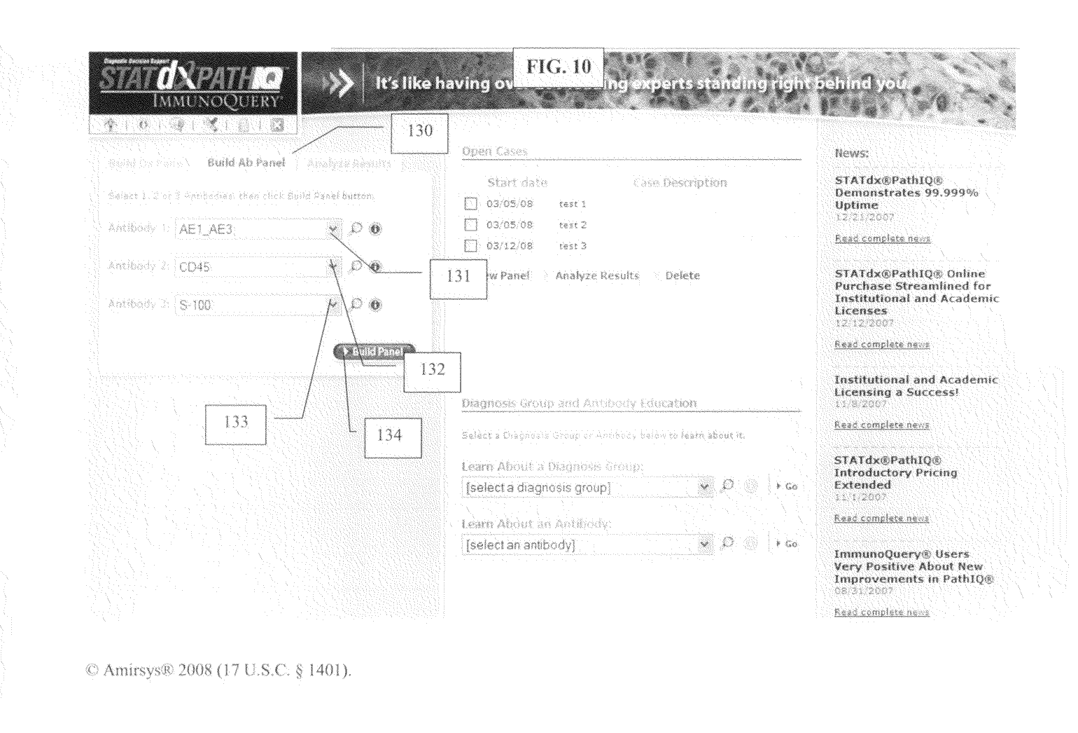

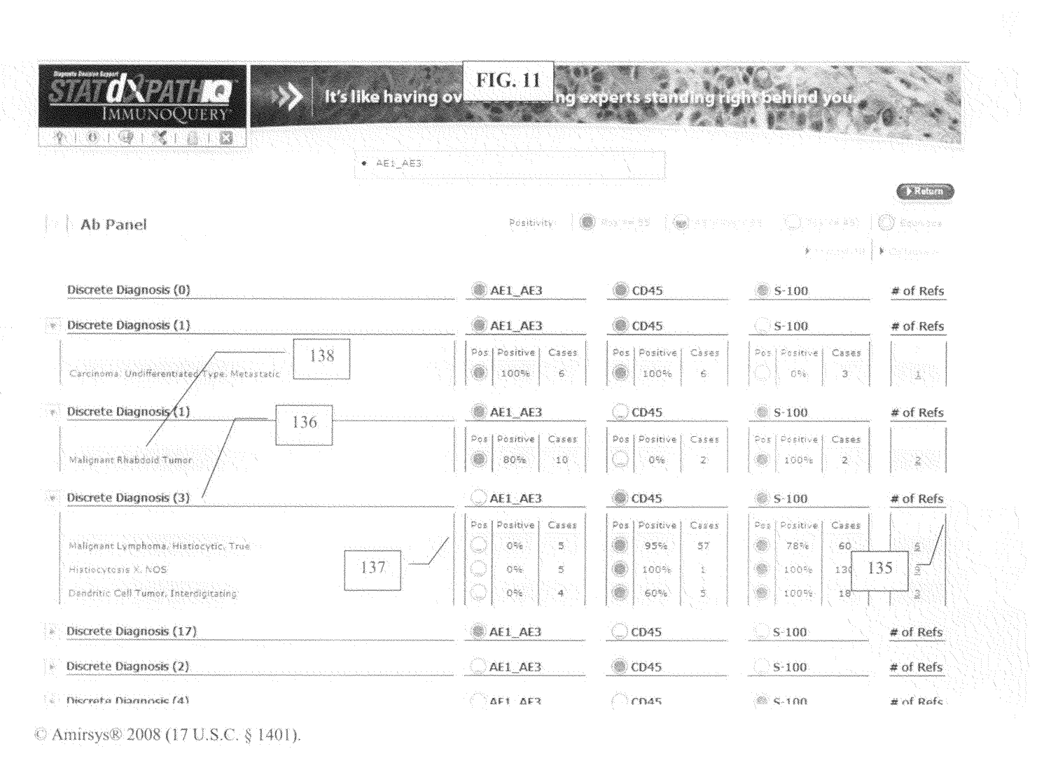

In the preferred embodiment, further meta-analysis of the reagents tested [1000] [1100] is accomplished by using the “Build Ab Panel” feature [130] shown in FIG. 10. There, the user may enter up to three antibodies, respectively [131], [132], and/or [133]. The meta-analysis of these antibodies is initiated by clicking the “Build Panel” button [134]. This presents the user with a new page or module [135] shown in FIG. 11. The meta-analysis by the system presents the user with various discrete diagnosis lists [136] and a user may compare the actual test results with combinations of hypothetical test results for individual diagnoses [137] [138] using the same antibodies in order to narrow potential diagnoses, or ultimately to make a conclusive diagnosis. More specifically, the user may find among the various hypothetical test results, an exact match with the actual test results previously obtained which corresponds to a single diagnosis [138]. In the event that multiple diagnoses are presented by this step in the meta-analysis [136], the user has obtained a new group of potential diagnoses from the system which he or she may now enter into the “Build Dx Panel” [110]. The user may, from this information, obtain a more appropriate panel of antibodies for diagnostic purposes.

Second, if despite following all of the above steps the user does not obtain a diagnosis, the user may then return and repeat previous steps [200]-[1000], but making various changes in the input to, or variables of the network-based system or re-examining and repeating steps outside the system in an attempt to obtain a definite diagnosis or diagnoses [1100]. Such changes may include inputting different suggested diagnoses to the system, further customizing the generated list of reagents in the system, conducting further reagent testing outside the system using different reagents, or re-examining the results of the reagent testing outside the system and re-comparing these results with the digital images and/or numerical measures inside the system.

Finally, several other features and tools of the system may assist the user in making diagnoses during any of the above-mentioned steps, and thereby constitute additional ancillary steps in the method. For example, the preferred embodiment incorporates several other features and tools to assist the user in making diagnoses during any of the above-mentioned steps. These features include an “Analyze Results” tab [138] which allows a user to compare up to five antibodies with a suspected diagnosis group as shown in FIG. 11 and a “Diagnosis Group and Antibody Education” feature [139] which allows a user to immediately access medical references and digital images relating to selected antibodies [140] and antibody groups or panels [141].

1. A diagnostic method comprising the steps of:
entering one or more potential diagnoses into a network-based system;
receiving from said system, in response to said entering of diagnoses, a list of potential reagents for differentiation of each diagnosis;
conducting reagent testing using the listed reagents or a subset thereof; obtaining the results from said testing;
entering said test results into the network-based system; initiating meta-analysis in said system whereupon the system, based upon the test results entered, generates either a diagnosis, diagnoses, or inconclusive results.

2. The method of claim 1 further comprising the step of electronically saving data input entered into the system.

3. The method of claim 1 further comprising the step of accessing the system using a username and password.

4. The method of claim 1 further comprising the step of selecting a confidence level for the network-based system to govern the meta-analysis.

5. The method of claim 1 further comprising the step of adjusting the sensitivity of the search criteria in the network-based system.

6. The method of claim 1 further comprising the step of selecting said subset of reagents based upon their ability to differentiate between suspected diagnoses.

7. The method of claim 1 further comprising the step of reviewing trade-specific references for reagents or groups of reagents compiled in the network-based system.

8. The method of claim 1 further comprising the step of reviewing numerical measures of each reagent's behavior in the system.

9. The method of claim 1 further comprising the step of reviewing digital images of results of reagent testing in the system.

10. The method of claim 1 further comprising the step of entering a reagent or group of reagents into the system to prompt meta-analysis which results in a list of hypothetical testing result permutations of the reagent or group of reagents.

11. The method of claim 10 further comprising the step of selecting the hypothetical result permutations of the reagent or group of reagents which most corresponds to the actual results of the reagent testing, in order to obtain a second list of potential diagnoses.

12. The method of claim 11 further comprising the step of entering the second list of possible diagnoses into the system and substantially repeating the steps of claim 1.

13. The method of claim 1 further comprising the step of repeating the steps of claim 1, if it is initially determined that results are inconclusive.

14. A diagnostic method comprising the steps of:
entering one or more potential medical diagnoses into a network-based system;
receiving from said system, in response to said entering of diagnoses, a list of potential antibodies for differentiation of each diagnosis;
conducting immunostain testing using the listed antibodies or a subset thereof;
obtaining the results from said testing;
entering said test results into the network-based system;
initiating meta-analysis in said system whereupon the system, based upon the test results entered, generates either a diagnosis, diagnoses, or inconclusive results.

15. The method of claim 14 further comprising the step of electronically saving data input entered into the system.

16. The method of claim 14 further comprising the step of selecting a confidence level for the network-based system to govern the meta-analysis.

17. The method of claim 14 further comprising the step of adjusting the sensitivity of the search criteria in. the network-based system.

18. The method of claim 14 further comprising the step of selecting said subset of antibodies based upon their ability to differentiate between suspected diagnoses.

19. The method of claim 14 further comprising the step of reviewing trade-specific references for antibodies or groups of antibodies compiled in the network-based system.

20. The method of claim 14 further comprising the step of reviewing numerical measures of each antibody's behavior in the system.

21-25. (canceled)
